(19) United States
(12) Patent Application Publication
(10) Pub. No.: US 2022/0343339 A1
(43) Pub. Date: Oct. 27, 2022

(54) SYSTEMS AND METHODS OF DIGITAL TRIGGERS AND DIGITAL TWINS

(71) Applicant: Avery Dennison Retail Information Services LLC, Mentor, OH (US)

(72) Inventors: Bhupesh ARORA, Tulsa, OK (US); Pradeep IYER, Lakewood, OH (US); Michael GOLLER, Graz (AT); Michael J. KUHNO, Youngsville, NC (US); Jeremy SCHENOF, Chicago, IL (US); Akari SHONO, Brooklyn, NY (US); Richard LORITSCH, La Crescenta, CA (US); Julie VARGAS, San Antonio, TX (US)

(21) Appl. No.: 17/761,732

(22) PCT Filed: Sep. 23, 2020
(86) PCT No.: PCT/US2020/052257

§ 371 Date: Mar. 18, 2022

Related U.S. Application Data
(60) Provisional application No. 62/904,245, filed on Sep. 23, 2019.

(51) Int. Cl. G06Q 30/00

(52) U.S. Cl. CPC G06Q 30/018

(57) ABSTRACT

In some embodiments, a computer processor-based method using at least one processor and at least one non-transitory computer readable memory, the method includes associating a first component and a first unique identifier with at least one of a plurality of digital twins for a group of final products, the first unique identifier corresponding to a first digital trigger. The method also includes updating at least one of the digital twins based on an evolution that is associated with the first component and that is at least part of a process resulting in a commercial product. The method also includes associating the at least one of the plurality of digital twins with the commercial product and a second unique identifier corresponding to a second digital trigger. The method may also include providing data associated with a trust condition.

### CROSS-REFERENCE TO RELATED APPLICATION

The present application claims the benefit of U.S. Provisional Patent Application No. 62/904,245 filed Sep. 23, 2019, which is incorporated herein by reference in its entirety.

### BACKGROUND

For some conventional systems, information regarding a product's history or validity may be unavailable, untimely, incomplete, or inaccurate. For example, a consumer may have no way of verifying whether an article of clothing is a real or counterfeit item other than by trusting that a printed brand name is accurate. In other examples, a consumer may have difficulty verifying the truth of claims made by a seller regarding such qualities as containing organic ingredients, proper delivery, the fact that a product is new, as well as to verify authenticity of products purchased from re-sellers.

While some conventional systems for verification may exist based on certification of an entire business, such as by a regulatory organization, such systems may not provide accurate or timely information in specific cases, such as at a specific item level. Such systems may also be subject to false claims of simply being certified.

Accordingly, improvements may be made over the conventional systems.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

In some embodiments, a computer processor-based method using at least one processor and at least one non-transitory computer readable memory includes associating a first component and a first unique identifier with at least one of a plurality of digital twins for a group of products, the first unique identifier corresponding to a first digital trigger.

In some embodiments, the method further includes updating at least one of the digital twins based on an evolution that is associated with the first component and that is at least part of a process resulting in a commercial product.

In still other embodiments, the method further includes associating the at least one of the plurality of digital twins with the commercial product and a second unique identifier, the second unique identifier corresponding to a second digital trigger. The method also includes, responsive to a first communication initiated based on the second digital trigger, providing data associated with a trust condition applicable to the first component and the final product.

The at least one digital trigger can be any digital trigger known in the art. In some embodiments, the at least one digital trigger is selected from one or more of an RFID device, a barcode, a QR code, a Bluetooth® device, BLE device, an NFC device, a recognizable image, a recognizable sound, and a wireless transmission.

In some embodiments, the first component may be used to form the commercial product, and the evolution includes a manufacturing process that alters the component. In some embodiments, the trust condition may include a distribution factor containing one or more of a manufacturer identity, a manufacturing authorization, a distributor authorization, a regional authorization, a new manufacture status, a prior sale, a recall status, and a repair confirmation.

In some embodiments, the trust condition may include at least one process factor including one or more of an organic process confirmation, a fair labor confirmation, a fair trade confirmation, a charitable support confirmation, a relationship confirmation, a food standard confirmation, a manufacturing step confirmation, and a cold chain confirmation.

In some embodiments, the trust condition may include at least one composition factor including one or more of a component material confirmation, an allergen confirmation, an organic ingredient confirmation, a non-GMO confirmation, an antibiotic-free confirmation, a free-range confirmation, a recycled material confirmation, and an ingredient confirmation.

The evolution may include a variety of different occurrences. In some embodiments, the evolution includes at least one occurrence of a manufacturing step involving the first component, a manufacturing step involving a product derived from the first component, and a manufacturing step involving the commercial product. In some embodiments, the evolution includes 1) including the first component into a group; and 2) creating a group identifier associated with the group. In some embodiments, the evolution includes separating the first component from a group. The evolution may include coupling the second digital trigger to the commercial product.

In some embodiments, the first digital trigger and the second digital trigger are the same trigger. In other embodiments, the first digital trigger and the second digital trigger are the same trigger types. In other embodiments, the first digital trigger and the second digital trigger are different trigger types. In some embodiments, the digital twin may be updated with the evolution of the target product based on a second communication initiated based on at least one of the first digital trigger and the second digital trigger.

In some embodiments, the method includes determining a context of the first communication. The content of the conditional data may be determined based on the context. The context may include one or more of a consumer identity, a manufacturer identity, a distributor identity, and a retail environment.

The component may vary. In some embodiments, the component includes at least one of a material, a part, a device, an ingredient, a food product, and an animal.

The consumer product may vary. In some embodiments, the consumer product includes at least one of a clothing article, produce, a drink, a food product, a meat product, a machine, a chemical, a fabric, an appliance, a vehicle, a tool, an electronic device, furniture, medical equipment, a toy, a game, a book, protective gear, medicine, a bandage, a mask, a drug, and a vaccine.

In some embodiments, the method may further include selecting a protocol for validation of the digital twin based on receipt of a second communication initiated based on a read of at least one of the first digital trigger and the second digital trigger. The method may include providing a user interface for a brand owner. The user interface may be configured to display information associated with the digital twin based on receipt of a second communication initiated based on a read of at least one of the first digital trigger and the second digital trigger. The method may include providing a user interface for permitting a brand owner to select a protocol for viewing information associated with the digital twin without receiving a communication from a digital trigger.

In some embodiments, a digital twin system includes a non-transitory computer readable memory and a processor coupled to the memory. The processor is configured based on instructions stored on the memory to associate a first component and a first unique identifier with at least one of a plurality of digital twins for a group of final products, the first unique identifier corresponding to a first digital trigger. The processor is also configured to update at least one of the digital twins based on an evolution that is associated with the first component and that is at least part of a process resulting in a commercial product. The processor is also configured to associate the at least one of the plurality of digital twins with the commercial product and a second unique identifier, the second unique identifier corresponding to a second digital trigger. The processor is also configured to, responsive to a communication initiated based on the second digital trigger, provide data associated with a trust condition applicable to the first component and the final product. Each of the first digital trigger and the second digital trigger have a trigger type that includes one or more of an RFID device, a barcode, a QR code, a Bluetooth® device, BLE device, an NFC device, a recognizable image, a recognizable sound, and a wireless transmission.

In some embodiments, the system may also include an access device configured to read at least one of the first digital trigger and the second digital trigger and, based on the read, initiate a communication to be received by at least one computer processor.

In some embodiments, a non-transitory computer readable memory includes software instructions configured to cause a computer processor, upon execution of the software instructions to associate a first component and a first unique identifier with at least one of a plurality of digital twins for a group of final products, the first unique identifier corresponding to a first digital trigger. The memory further includes instructions configured to cause the processor to update at least one of the digital twins based on an evolution that is associated with the first component and that is at least part of a process resulting in a commercial product. The memory further includes instructions configured to cause the processor to associate the at least one of the plurality of digital twins with the commercial product and a second unique identifier corresponding to a second digital trigger. The memory further includes instructions configured to cause the processor to, responsive to a communication initiated based on the second digital trigger, provide data associated with a trust condition applicable to the first component and the final product. Each of the first digital trigger and the second digital trigger have a trigger type comprising one or more of an RFID device, a barcode, a QR code, a Bluetooth® device, BLE device, an NFC device, a recognizable image, a recognizable sound, and a wireless transmission.

### BRIEF DESCRIPTION OF THE DRAWINGS

FIG. 1 is a schematic illustration of a digital twin system, according to some embodiments;

FIG. 2 is a schematic illustration of different aspects of the digital twin system, according to some embodiments;

FIG. 3 includes a block diagram representing evolution of various articles, according to some embodiments;

FIG. 4 includes a block diagram representing a process of verifying a trust condition, according to some embodiments;

FIG. 5 is a block diagram illustrating verification of information involving an additional data source, according to some embodiments;

FIG. 6 is a block diagram of an exemplary computer system, according to various embodiments; and

FIG. 7 are illustrative diagrams of computer program products, according to various embodiments.

### DETAILED DESCRIPTION OF EMBODIMENTS

As required, detailed embodiments of the present disclosure are set out herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner. The terms “one or more of a, b, and c”, “at least one of a, b, and c”, and “at least one of a, b, or c” are intended to refer to a, b, c, or combinations thereof including 1) one or multiple of a and one or multiple of b, 2) one or multiple of b and one or multiple of c, 3) one or multiple of a and one or multiple of c, 4) one or multiple of a, 5) one or multiple of b, or 6) one or multiple of c.

In various embodiments, a digital twin system may enable one or more entities such as manufacturers, distributors, retail entities, or a consumer to better track or otherwise understand key information associated with a specific consumer product. Such information may relate to trust conditions such as whether the consumer product is real or counterfeit, certified as organic, or includes particular ingredients. In other embodiments, key information may relate to a retail or brand story, care instructions, recall information, or other data. In various embodiments, information related to the consumer product may be accessed by, updated by, or provided by one or more entities via one or more digital triggers. In some embodiments, the system may be agnostic to the type of digital trigger used. In other embodiments, the system may operate differently based on the specific type of digital trigger being used and/or based on environmental conditions or contexts. Additional information regarding various embodiments is discussed in greater detail below.

### Exemplary Digital Twin Systems and Methods

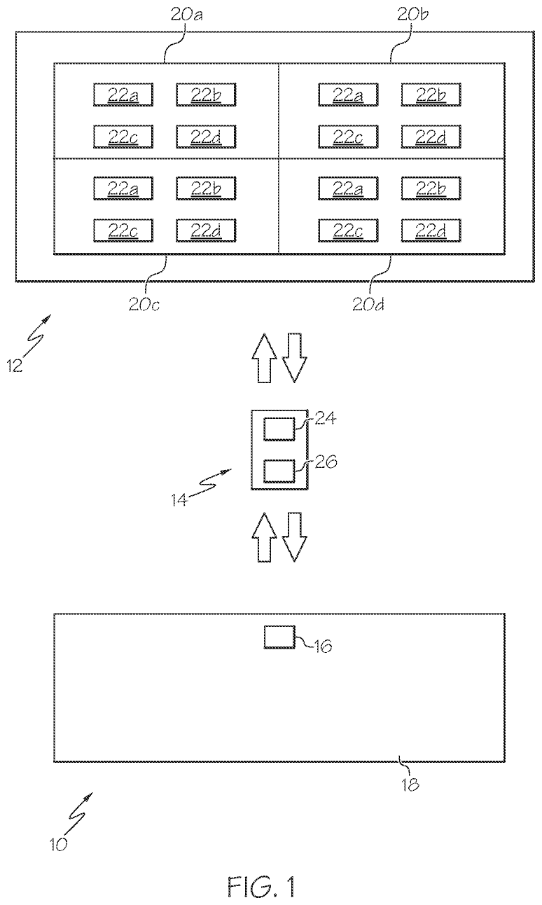

FIG. 1 shows the components of an exemplary digital twin system 10 according to some embodiments. The digital twin system 10 includes an electronic data storage system 12, and may include one or more of an access device 14, and one or more digital triggers 16 configured to be read and/or communicated with by the one or more access devices 14.

Each digital trigger may have one or more trigger types, including an RFID device, a barcode, a QR code, a Bluetooth® device, BLE device, an NFC device, a recognizable image, a recognizable sound, and a wireless transmission. Recognizable images may include a brand name, a slogan, a product shape, microscopic textures, ink splatter, leuco dyes, color-changing dye, UV visible images, heat-sensitive images, chemical sensitive images or dyes, magnetic ink, or other visible or latent indicia. Recognizable features may also include invisible indicia or indicia that are visible under certain circumstances. The RFID device may include one or more of an LF, HF, and a UHF device.

In some embodiments, the system may include at least 1, 2, 3, 4, 5, 6, 7, 8, 9, 10, or more digital triggers. The one or more access devices 14 may correspond to the trigger types used by the digital twin system 10, and may thus include one or more of a QR code reader, a barcode scanner, an RFID reader, a Bluetooth® reader, a BLE reader, an NFC reader, an image recognition system, an audio recognition system, a magnetic sensing system, and a wireless transceiver for communicating via wireless frequencies with electronic devices.

The system 10 further includes an article 18, which is to be the subject of a digital twin 20 that is stored in the electronic data storage system 12. For example, the article 18 may comprise a component, a material, a food, an ingredient, or a commercial product. Examples of a commercial product may include one or more of a clothing article, a food product, a machine, a chemical, a fabric, an appliance, a vehicle, a tool, an electronic device, furniture, medical equipment, a toy, a game, a book, protective gear, medicine, a bandage, a mask, a drug, a vaccine, or a consumer product intended for purchase or use by a consumer. A food product may include one or more of a vegetable, a fruit, a drink, a meat product, a dairy product, a seafood product, or a fish product. In addition, a component may include a commercial product that is used during the manufacture or assembly of another commercial product. For example, a bolt of cloth, a bag of supplies, a box of parts, or a volume of chemicals may each be a commercial product that is used as part of the manufacture of another commercial product, such as an article of clothing, or an electronic device. In addition, a shirt or pair of pants may each be a commercial product that is used as a component of a complete set sold as an individual commercial product. A final product may be a commercial product that is configured for sale or use by a consumer, such as through completion of one or more of manufacturing, packaging, shipping, and display by a retailer.

Each digital twin 20 may comprise an electronic record associated with a specific item, such as one article 18. In some embodiments, the digital twin 20 may be associated with two or more articles 18, such as a collection of articles 18 in a container or grouped together for transport.

In various embodiments, the electronic data storage system 12 is configured to store at least one digital twin 20a-20d (collectively referred to herein as digital twin 20), but may be configured to host a database populated with a plurality of digital twins 20. The electronic data storage system 12 may be suited for storing at least one digital twin 20 and (preferably) for communication with the access device 14. For example, the electronic data storage system 12 may be configured as a cloud storage system, a database, or as a more traditional local storage device (e.g., one or more computer hard drives operated using one or more computer processors).

The digital twin 20 stored by the electronic data storage system 12 may include a plurality of entries 22a-22d (collectively referred to herein as entries 22), and may contain information related to the article 18 and/or the digital trigger 16. At least one of the entries 22 comprises at least one unique identifier that corresponds to the digital trigger 16. In various embodiments, the unique identifier is also obtained by an access device 14 when reading a digital trigger 16. The digital twin 20 may thus be uniquely paired to the digital trigger 16. Through the digital trigger's 16 association with the unique identifier, the digital twin 20 may also be paired with the article 18.

### Unique Identifiers

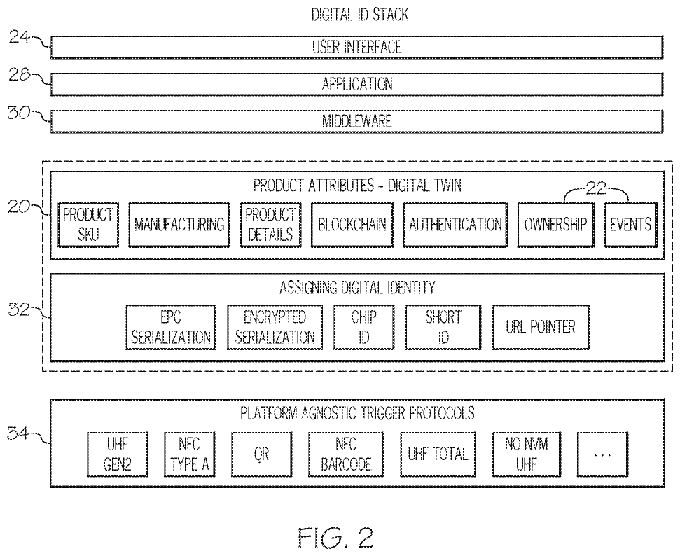

In various other embodiments, a digital trigger 16 and/or digital twin 20 may have a plurality of unique identifiers. For example, different unique identifiers may be associated with different wireless communication protocols or different types of information related to the same article 18 and/or the corresponding digital trigger 16. For example, one of the entries 22 of the digital twin 20 may include information related to the brand of the article 18 or its expiration date, a product stock keeping unit (“SKU”), manufacturing/factory management information, product attributes/details, a blockchain record, a Directed Acyclic Graph (DAG) record, distributed ledger tracked events, track/trace authentication, ownership, and events, as shown in FIG. 2.

In other embodiments, one or more of the digital triggers 18 may each be associated with a unique identifier, and multiple digital triggers 18 may be associated with a single article 18. For example, a single article 18 may be associated with two or more of QR codes, an RFID device and a UHF tag, or any combination of two or more of the same or different digital trigger 16 types listed above. Associating an article 18 with multiple digital triggers 18 may increase the ability of the manufacturers, distributors, consumers, or other entities to use a more convenient access device 14 to interact with at least one of the digital triggers 16.

Data may be entered into an entry 22 automatically (e.g., by a signal sent from a sensor associated with the article 18) or manually (e.g., by an operator using the access device 14 to input information regarding the article 18). The data may include one or more trust conditions, such as a distribution factor, a process factor, and/or a composition factor. Exemplary distribution factors may include one or more of a manufacturer identity, a manufacturing authorization, a distributor authorization, a regional authorization, a new manufacture status, a prior sale, a recall status, and a repair confirmation. Exemplary process factors may include one or more of an organic process confirmation, a fair labor confirmation, a fair trade confirmation, a charitable support confirmation, a relationship confirmation, a food standard confirmation, a manufacturing step confirmation, and a cold chain confirmation. Exemplary composition factors may include one or more of a component material confirmation, an allergen confirmation, an organic ingredient confirmation, a non-GMO confirmation, an antibiotic-free confirmation, a free-range confirmation, a recycled material confirmation, and an ingredient confirmation. The data entered into entry 22 regarding the trust condition may also indicate that information regarding a trust condition is unknown, ambiguous, or confirmed as untrustworthy. For example, where information cannot be automatically determined by the system, an entry may be given a null value or a not yet determined state.

Data may also relate to an evolution of an article 18 such as a component, material, or ingredient as it undergoes operations such as manufacturing, cooking, shipping, storage, refrigeration, registration, association with unique identifiers, and/or other processes. Various evolutionary operations may result in one or more transformations and/or modifications of the article 18 until a commercial product is created, delivered, and purchased.

### Access Device

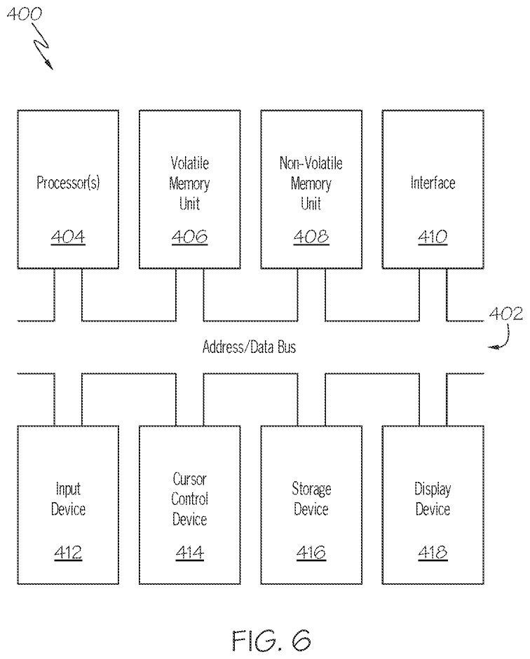

The access device 14 may include one or more components of the computer system 400 (see FIG. 6), and may be configured to act as an intermediary between the electronic data storage system 12 and the digital trigger 16. In other embodiments, the digital trigger 16 may be configured to directly interact with the electronic data storage system 12, without using the access device 14 as an intermediary. An access device 14 may be configured for communication with both the electronic data storage system 12 and the digital trigger 16, only with the electronic data storage system 12, or only with the digital trigger 16.

The access device 14 may be configured to communicate with the electronic data storage system 12 and/or one or more digital triggers 16. In some embodiments, the access device 14 comprises a “smart device” (such as a computer or tablet or smart phone) which is configured to communicate with other devices or networks via Wi-Fi, cellular communication, Bluetooth. The access device may further include a camera, a processor, and software configured to operate as an image recognition device such as for a barcode, a QR code, a brand name, a pre-registered image, a person, or other image.

The access device 14 may communicate via wired or wireless communication to the electronic data storage system 12 and/or the digital trigger 16. In various embodiments, the access device 14 may be incorporated into the electronic data storage system 12. For example, the electronic data storage system 12 may be or comprise a hard drive of a computer, and the access device 14 may be or comprise a peripheral connected or coupled to the computer, such as a barcode reader.

While one access device 14 is shown in FIG. 1, multiple access devices may communicate with a single electronic data storage system 12. This may include different access devices 14 for different digital twins 20 and/or different access devices 14 for the same digital twin 20 (each accessing the digital twin 20 using the same or different unique identifiers). For example, different entities and/or types of entities may be granted access to a digital twin 20 at different times or with different levels of access to the digital twin 20. For example, some exemplary entities may include a programmer or manager, a brand owner, and an end consumer. The programmer or manager of digital identities may be tasked with creating the digital twin 20 and/or populating one or more of the entries 22. The brand owner has access to the digital twin 20 for monitoring the performance and status of the article 18 (which may be used for improving manufacturing and/or factory management). In addition, an end user may be given limited access to the digital twin 20 for registering or transferring ownership of the article 18, viewing certain information regarding the article 18 (e.g., to authenticate the article 18 as being manufactured by the brand owner).

The access devices 14 of different entities may be different. For example, an access device 14 of a programmer may include a barcode reader and/or a smart device configured to communicate with both the electronic data storage system 12 and the digital trigger 16. The access device 14 of a brand owner may include a computer or smart device configured to communicate with only the electronic data storage system 12. In addition, the access device 14 of an end user may include a smart phone configured to communicate with the electronic data storage system 12 and the digital trigger 16.

In various embodiments, the access device 14 includes a user interface 24 and a reader 26 (e.g., as shown in FIG. 1). The user interface 24 (which is also shown in FIG. 2) may grant the user different abilities and access depending on the nature of the user. For example, the user interface 24 of a programmer may give the programmer the ability to create a digital twin 20, while giving other users the ability to track ownership of the article 18, record events and states throughout the life of the article 18, etc. In one exemplary embodiment, the user interface 24 may comprise a touch screen (e.g., the screen of a smartphone or tablet computer), with a user pressing and otherwise manipulating the screen to perform different activities within the user interface 24 (which may comprise a software program or phone application 28 supported by appropriate middleware 30, as shown in FIG. 2). In another exemplary embodiment, the user interface 24 may comprise a screen that a user interacts with using a peripheral device, such as a computer mouse.

The reader 26 may enable the access device 14 to interact with the electronic data storage system 12 and/or the digital trigger 16. While the access device 14 of FIG. 1 is shown with a single reader 26, it should be understood that a single access device 14 may include a plurality of readers 26, particularly if the access device 14 is configured to communicate with the electronic data storage system 12 and the readable member 14 using different communication protocols or trigger technologies.

The digital trigger 16 is configured to communicate with the access device 14, but may also be configured to communicate directly with the electronic data storage system 12. As described above, the digital trigger 16 is encoded with a unique, optionally serialized identifier to distinguish it from a digital trigger 16 associated with a different article 18. The identifier may take any suitable form, such as an electronic product code (“EPC”), chip ID, short ID, or unique URL pointer (as generally identified in FIG. 2 at 32). In addition to the identifier, the digital trigger 16 may be encoded with additional data, such as information regarding the manufacturer of the digital trigger 16.

### Digital Trigger

The manner in which the digital trigger 16 communicates with the access device 14 and/or the electronic data storage system 12 may be passive or active. The term “passive” refers to a digital trigger 16 that does not include an antenna or similar means for transmitting a signal, but instead relies entirely upon the access device 14 or electronic data storage system 12 transmitting a signal to (i.e., “scanning”) the digital trigger 16. The term “active” refers to a digital trigger 16 that includes an antenna or similar means for transmitting a signal, either with or without first receiving a signal from the electronic data storage system 12 or an access device 14.

In various embodiments, the digital trigger 16 comprises a one- or two-dimensional barcode. In another embodiment, the digital trigger 16 comprises a near field communication (“NEC”) or remote frequency identification (“RFID”) or Bluetooth Low Energy (“BLE”) tag or other wireless communication tag (as generally identified in FIG. 2 at 34). In some embodiments, if the digital trigger 16 is configured as a wireless communication tag, its chip or integrated circuit may have limited or no writable memory, or may store limited information, such as only a pointer, which may further reduce the cost of the digital trigger 16 and the cost of the digital twin system 10, thereby making it more practical to create a digital twin 20 for a less expensive article 18. A single electronic data storage system 12 may store digital twins 20 associated with differently configured readable members 16, rather than being limited to storage of digital twins 20 associated with only one type of digital trigger 16 (e.g., only readable members 16 configured as RFID tags).

The nature of the digital trigger 16 (i.e., the protocol by which it may be communicated with) may determine the nature of the reader 26 of the associated access device 14. Thus, if the digital trigger 16 comprises a barcode, the reader 26 may be capable of reading a barcode, whereas the reader 26 may comprise a RFID reader if the digital trigger 16 comprises an RFID tag. Some systems may include a smart phone or other smart device that is configured to be conversant in a plurality of communication protocols and/or trigger technologies, while other embodiments may include an access device 14 capable of communication in only one protocol (e.g., a one-dimensional barcode reader).

The digital twin system 10 of FIG. 1 may include additional components. For example, in addition to the digital trigger 16, the article 18 may include one or more sensors configured to independently provide additional information to the digital twin 20 regarding the article 18.

### Exemplary User Interfaces

Turning now to more particular ways in which a user may interact with the digital twin system 10, the user interface 24 of a programmer may provide a “create digital twin” menu item, which allows the programmer to create a digital twin 20 in the electronic data storage system 12. This may include allowing the programmer to select the brand of the digital trigger 16 to be paired to the digital twin 20 or of the article 18 to which the digital trigger 16 is to be associated. The user interface 24 may also provide the programmer with the ability to select the nature of the digital trigger 16 or the article 18. The programmer may then scan the digital trigger 16 (which may or may not be associated with the article 18 at the time that it is scanned by the programmer) using an access device 14. The unique identifier of the digital trigger 16 may be automatically entered into the appropriate entry 22 of the digital twin 20, with the user interface 24 optionally indicating to the programmer that the digital twin 20 has successfully been created and paired to the digital trigger 16. If the digital trigger 16 is encoded with any additional data to be transferred to the digital twin 20, it may also be transferred from the digital trigger 16 to the digital twin 20 upon scanning the digital trigger 16. In addition to automatically entering data into the electronic data storage system 12 by scanning the digital trigger 16, the user interface 24 may give the programmer the option of manually entering data (such a brand owner information) into the digital twin 20 via the user interface 24.

The user interface 24 may include an “add event to digital twin” menu item, which allows a user to provide event data to the digital twin 20. For example, the user interface 24 of a brand owner may include a list of events to be experienced by the digital trigger 16 and/or the article 18, such as shipping, receipt at a port of entry, receipt at a retail location, etc. Upon the occurrence of an event, a user selects the appropriate event from the list. If an event has an associated location (e.g., the location of a port of entry or retail location), the user interface 24 may allow the user to also enter that information. With the event (and, optionally, location) selected, the user may use an access device 14 to scan the digital trigger 16, thereby updating the digital twin 20 paired to the digital trigger 16 to include the event and (if applicable) location. The user interface 24 may indicate to the user that the event has successfully been added to the digital twin 20.

The user interface 24 may also include a “validate digital twin” menu item, which allows a user to validate a digital twin 20. After selecting such a menu item, a user may scan the digital trigger 16 to cause the user interface 24 to display information contained within the digital twin 20. The nature of the information may vary, such as with the user interface 24 of a brand owner providing different information to the user than the user interface 24 of an end user. Alternatively, rather than requiring a user to select a “validate digital twin” menu item, the digital twin system 10 may be configured such that a user may simply scan the digital trigger 16 to retrieve information from the digital twin 20. In one embodiment, information proprietary to the brand owner may be accessed and viewed only by selecting a “validate digital twin” menu item and then scanning the digital trigger 16, while more general information or value-added services (e.g., information of the type that would be of interest to an end user) may be accessed from the digital twin 20 and displayed on the user interface 24 by simply reading or scanning the digital trigger 16. A user interface 24 may include additional or alternative functionality.

### Exemplary Evolutions

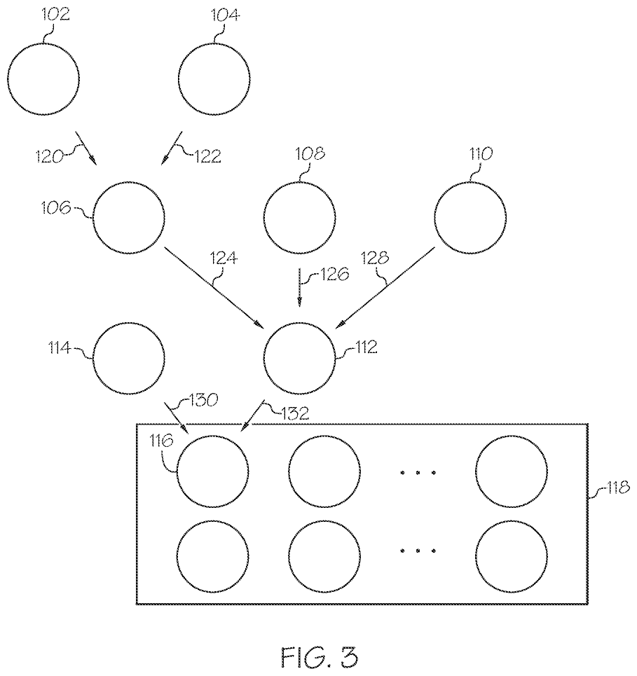

FIG. 3 includes a block diagram representing evolution of various articles 102, 104, 106, 108, 110, 112, 114, and 116, according to some embodiments. Each of the various articles may be associated with a corresponding unique identifier as well as a digital twin 20 for a final product (e.g., consumer product 216). One or more of the articles 102, 104, 106, 108, 110, 112, and 114 may be the same as article 18. Each of the various articles may undergo various processes or operations before creation of consumer product 116 which is associated with a specific digital twin 20.

Operations 120, 122, 124, 226, 128, 130, and 132 may include one or more manufacturing or food processing operations such as mixing, heating, cooling, forming, cutting, printing, attaching, welding, extruding, stamping, shaping, sewing, knitting, lateral movement, or rotation, among other possible operations. In other embodiments, evolution of articles may involve food processing operations, combination with ingredients, packaging, and/or transportation and delivery. For example, baking operations may involve mixing multiple ingredients, baking, and extraction from cookware.

Some exemplary operations may occur when two or more of articles 102, 104, 106, 108, 110, 112, 114, and 116 are grouped together. For example, two items such as a top and bottom of a track suit may be attached to each other to be sold as a unit. The operations performed on each item may include attachment to the other respective article or holding in place while receiving an attachment to another article. In another example, multiple components of a grouped item may need to be collected to form a transportation unit or retail unit. Retail units may include a tool set, a puzzle, a model, a furniture kit, or a meal. Transportation units may include being placed within a container or on a pallet. Operations for each part may include being moved to the location for grouping, being disposed at a location where other parts are being moved, or attachment to one or more other articles.

Before, during, or after evolutions, a digital trigger associated with the corresponding ones of articles 102, 104, 106, 108, 110, 112, 114, or 116 and/or the corresponding processes may be read that confirms the evolution occurring or otherwise registers a status of the corresponding articles involved with the electronic data storage system 12.

In FIG. 3, articles 102 and 104 are combined via operations 120 and 122, respectively, to form article 106. Articles 106, 108, and 110 are combined via operations 124, 126, and 128, respectively, to form article 112. Articles 112 and 114 are combined via operations 130 and 132, respectively, to form consumer product 116. Consumer product 116 may be part of a group 118 of otherwise identical consumer products, each associated with a different corresponding digital twin 20. In some embodiments, one or more of the articles 102, 104, 106, 108, 110, 112, and 114 may be used to form two or more of the group 118 of consumer products 116.

### Verifying a Trust Condition

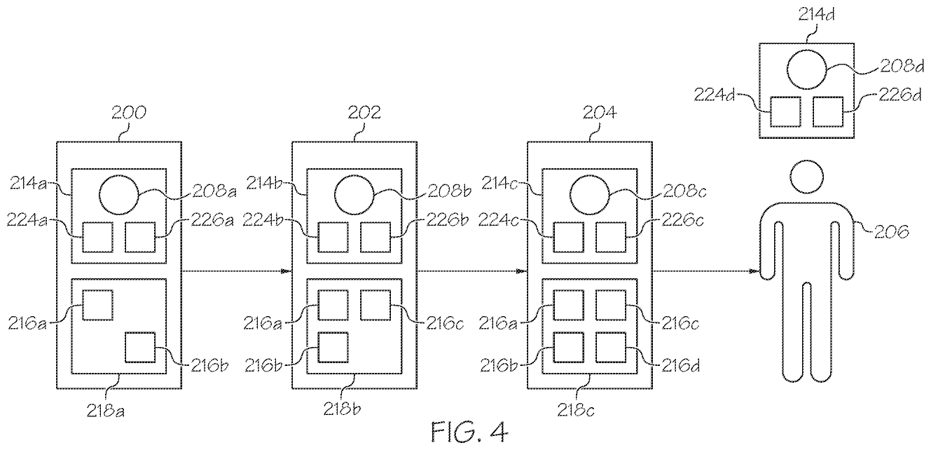

FIG. 4 includes a block diagram representing a process of verifying a trust condition according to some embodiments. FIG. 4 includes a manufacturer 200, a distributor 202, a retail entity 204, and a consumer 206. FIG. 4 also includes articles 218a, 218b, 218c, and 218d, manufacturer identity 208a, distributor identity 208b, retail identity 208c, and consumer identity 208d, access device 214a, 214b, 214c, 214d, user interface 224a, 224b, 224c, 224d, and reader 226a, 226b, 226c, 226d. In various embodiments, one or more of the articles 18, 102, 104, 106, 108, 110, 112, 114, and 116 may be the same as one or more of the articles 218a, 218b, 218c, and 218d.

In the embodiments of FIG. 4, an article 218a may be received by manufacturer 200 that performs one or more operations (see FIG. 3) to cause evolution of the article 218a into the article 218b. In various embodiments, the article 218a may include one or more of a digital trigger 216a (e.g., a first digital trigger) and a digital trigger 216b (e.g., a second digital trigger), or additional digital triggers. In other embodiments, the manufacturer 200 may add the second digital trigger 216b to the article 218a.

In various embodiments, the manufacturer 200 may attach to a single article 218a two or more types of digital triggers. These may include two more of a bar code, a QR code, an NFC tag, a Bluetooth® or BLE tag, and an RFID tag. Each digital trigger may be associated with a unique identifier, and the manufacturer may cause multiple unique identifiers to be paired with the article 218a as well as a digital twin 20 for an end product 218c. The RFID tag may be more convenient for the manufacturer 200 to read, while one or more of the QR code, the NFC tag, or the Bluetooth or BLE tag may be easier for the distributor 202, the retailer 204, or the consumer 206 to read.

One or more of the manufacturer's 200 receipt of the article 218a and performance of one or more operations (e.g., attaching digital triggers, performing manufacturing steps) may include manually or automatically causing a reader 226a of an access device 214a to read one or more of the digital triggers 216a, 216b associated with the article 218a or the article 218b, which may initiate one or more communications with the electronic data storage system 12.

The communications may result in data being provided to the electronic data storage system 12. This data may include information about one or more of the manufacturer's identity 208a, the article 218a, and the one or more operations performed by the manufacturer that may cause evolution of the article 218a into the article 218b. This data and/or the article 218a may further be associated with a digital twin 20 for a consumer product (e.g., the article 208c). For example, some components such as raw materials, parts, fabric, thread, dyes, or chemicals that are received by the manufacturer 200 may be associated with multiple final products (e.g., consumer products) to be made using the components. One component, such as a large volume of fabric or chemicals, may thus become associated with 1, 10, 50, or more final products. For example, a digital twin 20 of a shirt, article of clothing, or fabric that has not yet been created may become associated with the fabric or chemicals that will be used to create the shirt, article of clothing, or fabric at a manufacturing stage.

The article 218b may be received by a distributor 208b that performs operations that may cause the article 218b to evolve into the article 218c. These operations may also involve automatically or manually causing a reader 226b of an access device 214b to read one or more digital triggers, 216a, 216b, 216c associated with the article 218b or the article 218c, which in turn may result in data being provided to the electronic data storage system 12. This data may include information about one or more of the distributor's identity 208b, the article 218b, and the one or more operations performed by the distributor. This data and/or the article 218b may further be associated with a digital twin 20 for the consumer product (e.g., the article 208c).

The article 218c may be received by a retailer 204 that receives, stores, and sells the article 218c, such as to a consumer 206. The retailer 204 may have a retailer identity 208c. One or more of the retailer's operations may also involve automatically or manually causing a reader 226c of an access device 214c to read one or more digital triggers 216a, 216b, 216c, 216d associated with the article 218c, which in turn may result in data being provided to the electronic data storage system 12. This data may include information about one or more of the distributor's identity 208b, the consumer's identity 208c, the article 218c, and the one or more operations performed by the distributor. This data and/or the article 218b may further be associated with a digital twin 20 for the consumer product (e.g., the article 208c).

### Data Access

In various embodiments, prior to, during, and after purchase, the consumer 206 may use an access device 214 (e.g., smartphone) to read one or more of digital triggers 216a, 216b, 216c, 216d that are associated with the consumer product (e.g., the article 208c, a final product). By reading one or more digital triggers 216a, 216b, 216c, 216d, the access device 214 may initiate a communication to the electronic data storage system 12.

Based on the read, the consumer 206 may be given access via the electronic data storage system 12 to some or all of the digital twin 20 and/or to some or all of the associated data. For example, the consumer may receive data relating to one or more of a trust condition associated with the consumer product, the manufacturer 200, the distributor 202, the retailer 204, the manufacturer's identity 208a, the distributor's identity 208b, and the retailer's identity 208c, the article 218a, 218b, 218c, and the operations performed by one or more of the manufacturer 200, the distributor 202, and the retailer 204 with respect to articles that were involved in making the consumer product available to the consumer 206. Such data may include relevant times, dates, and locations for various operations and/or entities. Such data may also include associated worker information for persons involved in manufacture, assembly, transport, and sale of the consumer product. Such data may further be anonymized, such as by providing an employee number rather than other identifying information.

In various embodiments, based on the data, the consumer 206 may be able to verify items, such as whether an article of clothing is genuine, that a meal is organic, that a food does or does not contain allergens, that the manufacturer of a product adhered to fair labor, environmental, or other standards, or that the consumer product is or isn't subject to recall.

In some embodiments, the consumer 206 may read the same digital trigger 16 used by a manufacturer or distributor, such as an embedded RFID tag or a QR code imprinted on a consumer product, its package, or a label. In such instances, the consumer 206 may be given different information by the electronic data storage system 12 than would be provided to the manufacturer or distributor. For example, a manufacturer 200 may receive manufacturing instructions after scanning a QR codes, while a consumer 206 may receive a manufacturer 200 or retailer 204 marketing message. The electronic data storage system 12 may automatically provide different information based on the identity 208a, 208b, 208c, 208d associated with an access device used by the relevant entity. In other embodiments, different digital triggers 216a, 216b, 216c, 216d may be associated with different information to be provided to different entities with different capabilities or equipment (e.g., RFID readers vs QR code readers).

### Data Verification or Other Analysis

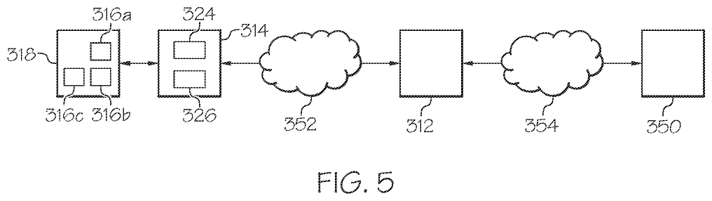

FIG. 5 is a block diagram illustrating verification of information involving an additional data source, according to various embodiments. FIG. 5 includes an article 318, digital triggers 316a, 316b, 316c, an access device 314, a user interface 324, a reader 326, a network 352, an electronic data storage system 312, a network 354, and an additional data source 350. In various embodiments, one or more of the articles 18, 102, 104, 106, 108, 110, 112, 114, 116, 218a, 218b, 218c, and 218d may be the same as one or more of article 318.

In some embodiments, when an entity uses a reader 326 of an access device 314 to read one or more of a digital trigger 316a, 316b, 316c. Reading the one or more digital triggers 316a, 316b, 316c may allow an entity to initiate communication via a network 352 with an electronic data storage system 312 to either provide data or retrieve data.

In some embodiments, in order to update a trust confirmation or otherwise provide data regarding a trust condition, the electronic data storage system 312 may use data provided as a result of the read of the one or more digital triggers 316a, 316b, 316c to communicate with the additional data source 350 via the network 354. The additional data source 350 may represent additional computing resources managed by a third party, such as for certification of a trust factor. For example, the additional data source 350 may have data capable of verifying that a manufacturer satisfies fair labor standards based on the identity information provided as a result of the read of the one or more digital triggers 316a, 316b, 316c, and/or information related to one or more of the articles 18, 102, 104, 106, 108, 110, 112, 114, 116, 218a, 218b, 218c, 218d, and 318.

### Exemplary Computer System

A block diagram depicting an example of a system (i.e., computer system 400) that may be used to process signals and/or perform operations described in this disclosure is provided in FIG. 6. The computer system 400 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 400. When executed, the instructions cause the computer system 400 to perform specific actions and exhibit specific behavior, such as described herein.

The computer system 400 may include an address/data bus 402 that is configured to communicate information. Additionally, one or more data processing units, such as a processor 404 (or processors), are coupled with the address/data bus 402. The processor 404 is configured to process information and instructions. In an aspect, the processor 404 is a microprocessor. Alternatively, the processor 404 may be a different type of processor such as a parallel processor, application-specific integrated circuit (ASIC), programmable logic array (PLA), complex programmable logic device (CPLD), or a field programmable gate array (FPGA).

The computer system 400 is configured to utilize one or more data storage units. The computer system 400 may include a volatile memory unit 406 (e.g., random access memory (“RAM”), static RAM, dynamic RAM, etc.) coupled with the address/data bus 402, wherein a volatile memory unit 406 is configured to store information and instructions for the processor 404. The computer system 400 further may include a non-volatile memory unit 408 (e.g., read-only memory (“ROM”), programmable ROM (“PROM”), erasable programmable ROM (“EPROM”), electrically erasable programmable ROM “EEPROM”), flash memory, etc.) coupled with the address/data bus 402, wherein the non-volatile memory unit 408 is configured to store static information and instructions for the processor 404. Alternatively, the computer system 400 may execute instructions retrieved from an online data storage unit such as in “Cloud” computing. In an aspect, the computer system 400 also may include one or more interfaces, such as an interface 410, coupled with the address/data bus 402. The one or more interfaces are configured to enable the computer system 400 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 400 may include an input device 412 coupled with the address/data bus 402, wherein the input device 412 is configured to communicate information and command selections to the processor 100. In accordance with one aspect, the input device 412 is an alphanumeric input device, such as a keyboard, that may include alphanumeric and/or function keys. Alternatively, the input device 412 may be an input device other than an alphanumeric input device. In an aspect, the computer system 400 may include a cursor control device 414 coupled with the address/data bus 402, wherein the cursor control device 414 is configured to communicate user input information and/or command selections to the processor 100. In an aspect, the cursor control device 414 is implemented using a device such as a mouse, a track-ball, a track-pad, an optical tracking device, or a touch screen. The foregoing notwithstanding, in an aspect, the cursor control device 414 is directed and/or activated via input from the input device 412, such as in response to the use of special keys and key sequence commands associated with the input device 412. In an alternative aspect, the cursor control device 414 is configured to be directed or guided by voice commands.

In an aspect, the computer system 400 further may include one or more optional computer usable data storage devices, such as a storage device 416, coupled with the address/data bus 402. The storage device 416 is configured to store information and/or computer executable instructions. In one aspect, the storage device 416 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 418 is coupled with the address/data bus 402, wherein the display device 418 is configured to display video and/or graphics. In an aspect, the display device 418 may include a cathode ray tube (“CRT”), liquid crystal display (“LCD”), field emission display (“FED”), Light Emitting Diode (“LED)”, plasma display, or any other display device suitable for displaying video and/or graphic images and alphanumeric characters recognizable to a user.

The computer system 400 presented herein is an example computing environment in accordance with an aspect. However, the non-limiting example of the computer system 400 is not strictly limited to being a computer system. For example, an aspect provides that the computer system 400 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

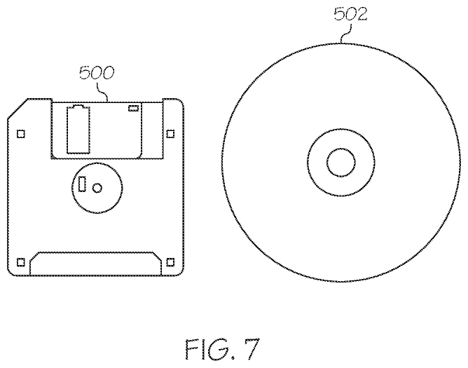

An illustrative diagram of a computer program product (i.e., storage device) is depicted in FIG. 7. The computer program product is depicted as floppy disk 500 or an optical disk 502 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A computer processor-based method using at least one processor and at least one non-transitory computer readable memory, the method comprising:
associating a first component and a first unique identifier with at least one of a plurality of digital twins for a group of final products, the first unique identifier corresponding to a first digital trigger;
updating at least one of the digital twins based on an evolution that is associated with the first component and that is at least part of a process resulting in a commercial product;
associating the at least one of the plurality of digital twins with the commercial product and a second unique identifier, the second unique identifier corresponding to a second digital trigger; and
responsive to a first communication initiated based on the second digital trigger, providing data associated with a trust condition applicable to the first component and the final product,
wherein each of the first digital trigger and the second digital trigger have a trigger type comprising one or more of an RFID device, a barcode, a QR code, a Bluetooth® device, BLE device, an NFC device, a recognizable image, a recognizable sound, and a wireless transmission.

2. The method of claim 1, wherein the first component is used to form the commercial product, and the evolution comprises a manufacturing process that alters the component.

3. The method of claim 1, wherein the trust condition comprises a distribution factor comprising one or more of a manufacturer identity, a manufacturing authorization, a distributor authorization, a regional authorization, a new manufacture status, a prior sale, a recall status, and a repair confirmation.

4. The method of claim 1, wherein the trust condition comprises at least one process factor comprising one or more of an organic process confirmation, a fair labor confirmation, a fair trade confirmation, a charitable support confirmation, a relationship confirmation, a food standard confirmation, a manufacturing step confirmation, and a cold chain confirmation.

5. The method of claim 1, wherein the trust condition comprises at least one composition factor comprising one or more of a component material confirmation, an allergen confirmation, an organic ingredient confirmation, a non-GMO confirmation, an antibiotic-free confirmation, a free-range confirmation, a recycled material confirmation, and an ingredient confirmation.

6. The method of claim 1, wherein the evolution comprises at least one occurrence of a manufacturing step involving the first component, a manufacturing step involving a product derived from the first component, and a manufacturing step involving the commercial product.

7. The method of claim 1, wherein the evolution comprises:
including the first component into a group; and
creating a group identifier associated with the group.

8. The method of claim 1, wherein the evolution comprises separating the first component from a group.

9. The method of claim 1, wherein the evolution comprises coupling the second digital trigger to the commercial product.

10. The method of claim 1, wherein the first digital trigger and the second digital trigger are the same trigger.

11. The method of claim 1, wherein the first digital trigger and the second digital trigger have the same trigger types.

12. The method of claim 1, wherein the first digital trigger and the second digital trigger have different trigger types.

13. The method of claim 1, wherein the digital twin is updated with the evolution of the target product based on a second communication initiated based on at least one of the first digital trigger and the second digital trigger.

14. The method of claim 1, further comprising:
determining a context of the first communication,
wherein the content of the conditional data is determined based on the context.

15. The method of claim 14, wherein the context comprises one or more of a consumer identity, a manufacturer identity, a distributor identity, and a retail environment.

16. The method of claim 1, wherein the component comprises at least one of a material, a part, a device, an ingredient, a food product, and an animal.

17. The method of claim 1, wherein the consumer product comprises at least one of a clothing article, produce, a drink, a food product, a meat product, a machine, a chemical, a fabric, an appliance, a vehicle, a tool, an electronic device, furniture, medical equipment, a toy, a game, a book, protective gear, medicine, a bandage, a mask, a drug, and a vaccine.

18. The method of claim 1, further comprising selecting a protocol for validation of the digital twin based on receipt of a second communication initiated based on a read of at least one of the first digital trigger and the second digital trigger.

19. The method of claim 1, further comprising providing a user interface for a brand owner, the user interface being configured to display information associated with the digital twin based on receipt of a second communication initiated based on a read of at least one of the first digital trigger and the second digital trigger.

20. The method of claim 1, further comprising providing a user interface for permitting a brand owner to select a protocol for viewing information associated with the digital twin without receiving a communication from a digital trigger.

21. A digital twin system comprising:
a non-transitory computer readable memory;
a processor coupled to the memory and configured based on instructions stored on the memory to:
associate a first component and a first unique identifier with at least one of a plurality of digital twins for a group of final products, the first unique identifier corresponding to a first digital trigger;
update at least one of the digital twins based on an evolution that is associated with the first component and that is at least part of a process resulting in a commercial product;
associate the at least one of the plurality of digital twins with the commercial product and a second unique identifier, the second unique identifier corresponding to a second digital trigger; and
responsive to a communication initiated based on the second digital trigger, provide data associated with a trust condition applicable to the first component and the final product,
wherein each of the first digital trigger and the second digital trigger have a trigger type comprising one or more of an RFID device, a barcode, a QR code, a Bluetooth® device, BLE device, an NFC device, a recognizable image, a recognizable sound, and a wireless transmission.

22. The system of claim 21, further comprising an access device configured to read at least one of the first digital trigger and the second digital trigger and, based on the read, initiate a communication to be received by at least one computer processor.

23. The system of claim 21, wherein the first component is used to form the commercial product, and the evolution comprises a manufacturing process that alters the component.

24. The system of claim 21, wherein the trust condition comprises a distribution factor comprising one or more of a manufacturer identity, a manufacturing authorization, a distributor authorization, a regional authorization, a new manufacture status, a prior sale, a recall status, and a repair confirmation.

25. The system of claim 21, wherein the trust condition comprises at least one process factor comprising one or more of an organic process confirmation, a fair labor confirmation, a fair trade confirmation, a charitable support confirmation, a relationship confirmation, a food standard confirmation, a manufacturing step confirmation, and a cold chain confirmation.

26. The system of claim 21, wherein the trust condition comprises at least one composition factor comprising one or more of a component material confirmation, an allergen confirmation, an organic ingredient confirmation, a non-GMO confirmation, an antibiotic-free confirmation, a free-range confirmation, a recycled material confirmation, and an ingredient confirmation.

27. The system of claim 21, wherein the evolution comprises at least one occurrence of a manufacturing step involving the first component, a manufacturing step involving a product derived from the first component, and a manufacturing step involving the commercial product.

28. The system of claim 21, wherein the evolution comprises:
including the first component into a group; and
creating a group identifier associated with the group.

29. The system of claim 21, wherein the evolution comprises separating the first component from a group.

30. The system of claim 21, wherein the evolution comprises coupling the second digital trigger to the commercial product.

31. The system of claim 21, wherein the first digital trigger and the second digital trigger are the same trigger.

32. The system of claim 21, wherein the first digital trigger and the second digital trigger have the same trigger types.

33. The system of claim 21, wherein the first digital trigger and the second digital trigger have different trigger types.

34. The system of claim 21, wherein the digital twin is updated with the evolution of the target product based on a second communication initiated based on at least one of the first digital trigger and the second digital trigger.

35. The system of claim 21, further comprising:
determining a context of the first communication,
wherein the content of the conditional data is determined based on the context.

36. The system of claim 35, wherein the context comprises one or more of a consumer identity, a manufacturer identity, a distributor identity, and a retail environment.

37. The system of clam 21, wherein the component comprises at least one of a material, a part, a device, an ingredient, a food product, and an animal.

38. The system of claim 21, wherein the consumer product comprises at least one of a clothing article, produce, a drink, a food product, a meat product, a machine, a chemical, a fabric, an appliance, a vehicle, a tool, an electronic device, furniture, medical equipment, a toy, a game, a book, protective gear, medicine, a bandage, a mask, a drug, and a vaccine.

39. The system of claim 21, further comprising selecting a protocol for validation of the digital twin based on receipt of a second communication initiated based on a read of at least one of the first digital trigger and the second digital trigger.

40. The system of claim 21, further comprising providing a user interface for a brand owner, the user interface being configured to display information associated with the digital twin based on receipt of a second communication initiated based on a read of at least one of the first digital trigger and the second digital trigger.

41. The system of claim 21, further comprising providing a user interface for permitting a brand owner to select a protocol for viewing information associated with the digital twin without receiving a communication from a digital trigger.

42. A non-transitory computer readable memory comprising software instructions configured to cause a computer processor, upon execution of the software instructions to:
associate a first component and a first unique identifier with at least one of a plurality of digital twins for a group of final products, the first unique identifier corresponding to a first digital trigger;
update at least one of the digital twins based on an evolution that is associated with the first component and that is at least part of a process resulting in a commercial product;
associate the at least one of the plurality of digital twins with the commercial product and a second unique identifier corresponding to a second digital trigger; and
responsive to a communication initiated based on the second digital trigger, providing data associated with a trust condition applicable to the first component and the final product,
wherein each of the first digital trigger and the second digital trigger have a trigger type comprising one or more of an RFID device, a barcode, a QR code, a Bluetooth® device, BLE device, an NFC device, a recognizable image, a recognizable sound, and a wireless transmission.
